(19) United States
(12) Patent Application Publication
(10) Pub. No.: US 2025/0252728 A1
(43) Pub. Date: Aug. 7, 2025

(54) SYSTEM, APPARATUS, AND METHOD WITH IMAGE CLASSIFICATION

(71) Applicant: Samsung Electronics Co., Ltd., Suwon-si (KR)

(72) Inventors: Chanho AHN, Suwon-si (KR); Kikyung KIM, Suwon-si (KR); Seungju HAN, Suwon-si (KR)

(73) Assignee: Samsung Electronics Co., Ltd., Suwon-si (KR)

(21) Appl. No.: 19/044,093

(22) Filed: Feb. 3, 2025

(30) Foreign Application Priority Data
Feb. 1, 2024 (KR) 10-2024-0016204

(51) Int. Cl. G06V 10/70; G06V 10/764; G06V 10/776; G06V 10/82

(52) U.S. Cl. CPC G06V 10/87; G06V 10/764; G06V 10/776; G06V 10/82

(57) ABSTRACT

An electronic device includes one or more processors configured to select a classification model for classifying an image from among classification models based on additional information of the image by using an artificial intelligence (AI) model, and classify the image by using the selected classification model.

### CROSS-REFERENCE TO RELATED APPLICATIONS

This application claims priority to and the benefit under 35 USC § 119 (a) of Korean Patent Application No. 10-2024-0016204 filed in the Korean Intellectual Property Office on Feb. 1, 2024, the entire disclosure of which is incorporated herein by reference for all purposes.

### BACKGROUND

### 1. Field

The following description relates to a device, system, and method with image classification.

### 2. Description of Related Art

For a large language model (LLM) and a vision language model (VLM), various general information such as class information may be added to images. Information added to image data may be applied to general visual classification problems.

Typical artificial intelligence models may improve performance by learning the classifying problems on separate data sets. When multiple data sets are simultaneously trained for a single artificial intelligence model, performance may improve, but performance may also worsen. To solve these drawbacks, shared portions may be designed efficiently so that only specific portions of the data set may be shared with the artificial intelligence model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors configured to select a classification model for classifying an image from among classification models based on additional information of the image by using an artificial intelligence (AI) model, and classify the image by using the selected classification model.

The AI model and the classification models may be sequentially trained, and the classification models may be trained through a supervised learning based on a selection of the classification models by the trained AI model.

The AI model may be trained through a reinforcement learning, and for the reinforcement learning, the one or more processors may be configured to select the classification model according to a policy based on additional information of a training image in a training set for the reinforcement learning, receive a reward determined based on a change of performance of the selected classification model, and update the policy based on the reward.

The reward may be determined based on a difference between a performance score of the selected classification model and a reference performance score determined by using an evaluation image and additional information of the evaluation image.

The reference performance score may be determined based on either one or both of an arbitrary value, and the evaluation image and the additional information of the evaluation image prior to the training of the AI model.

The selected classification model used in the reinforcement learning of the AI model may have fewer layers than the trained classification models trained through the supervised learning.

The classification model used in the reinforcement learning of the AI model may be learned in advance by using a data set that is different from the training set.

The additional information may include information of domains to which the image belongs.

For the selecting of the classification model, the one or more processors may be configured to output scores corresponding to respective classification models between 0 and 1 from the additional information by using the AI model.

A first classification model may be selected from among the classification models in response to the AI model outputting the score of less than a predetermined value and a second classification model may be selected from among the classification models in response to the AI model outputting the score of equal to or greater than the predetermined value.

For the selecting of the classification model, the one or more processors may be configured to select one of the classification models based on scores corresponding to respective classification models determined from the additional information by using the AI model.

In one or more general aspects, a processor-implemented method includes training an artificial intelligence (AI) model by selecting a classification model for classifying an image according to a policy based on additional information of the image, determining a reward according to performance of the selected classification model that may be trained based on the image, and updating the policy based on the reward.

Theupdating of the policy based on the reward may include updating the policy such that the selecting of the classification model maximizes the reward according to the evaluated performance.

The determining of the reward according to the performance of the selected classification model that may be trained based on the image may include determining a performance score of the selected classification model trained based on the image, and determining the reward based on a difference between the evaluated performance score of the selected classification model and a reference performance score.

In one or more general aspects, an electronic system includes an image capturing device configured to acquire an image of the semiconductor product and generate additional information of the image, and an image classifying device configured to select a classification model for classifying the image from among classification models by using an artificial intelligence (AI) model based on the additional information of the image and classify the image by using the selected classification model.

The classification models may be sequentially trained through a supervised learning based on selection of the AI model.

The AI model may be trained through a reinforcement learning comprising selecting the classification model according to a policy based on additional information of a training image in a training set, receiving a reward determined based on a change of performance of the selected classification model, and updating the policy based on the reward.

The classification model used in the reinforcement learning of the AI model may be learned in advance by using a data set that is different from the training set.

The additional information may include information of domains to which the image belongs.

The selected classification model may be determined from among the classification models in response to the AI model outputting a score between 0 and 1 from the additional information.

Other features and aspects will be apparent from the following detailed description, the drawings, and the claims.

### BRIEF DESCRIPTION OF THE DRAWINGS

FIG. 1 illustrates an image classifying device according to one or more embodiments.

FIG. 2 illustrates a method for training an image classifying device according to one or more embodiments.

FIG. 3 illustrates a method for training an image classifying device according to one or more embodiments.

FIG. 4 illustrates a method for training a classification model according to one or more embodiments.

FIG. 5 illustrates a reinforcement learning structure of a model selector according to one or more embodiments.

FIG. 6 illustrates a method for training a model selector using a trained classification model according to one or more embodiments.

FIG. 7 illustrates a method for training a classification model using a trained model selector according to one or more embodiments.

FIG. 8 illustrates an image classifying device according to an example.

FIG. 9 illustrates an image classifying system of a semiconductor product according to one or more embodiments.

FIG. 10 illustrates a neural network according to one or more embodiments.

FIG. 11 illustrates an image classifying device according to another example.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Throughout the specification, when a component, layer, or element is described as being “on,” “connected to,” “coupled to,” or “joined to” another component, layer, or element, it may be directly (e.g., in contact with the other component, element, or layer) “on,” “connected to,” “coupled to,” or “joined to” the other component, layer, or element, or there may reasonably be one or more other components, layers, or elements intervening therebetween. When a component, layer, or element is described as being “directly on,” “directly connected to,” “directly coupled to,” or “directly joined to” another component, layer, or element, there can be no other components, layers, or elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The artificial intelligence model (AI model) of the description is a machine learning model that learns at least one task (task) and can be implemented as a computer program executed by a processor. The task learned by the AI model may refer to a problem to be solved through machine learning or a work to be performed through machine learning. AI models may be implemented as computer programs that run on computing devices, downloaded over a network, or sold in a product form. Alternatively, the AI model may be connected to various devices through a network. Also, the AI model may be interoperable with various devices through a network.

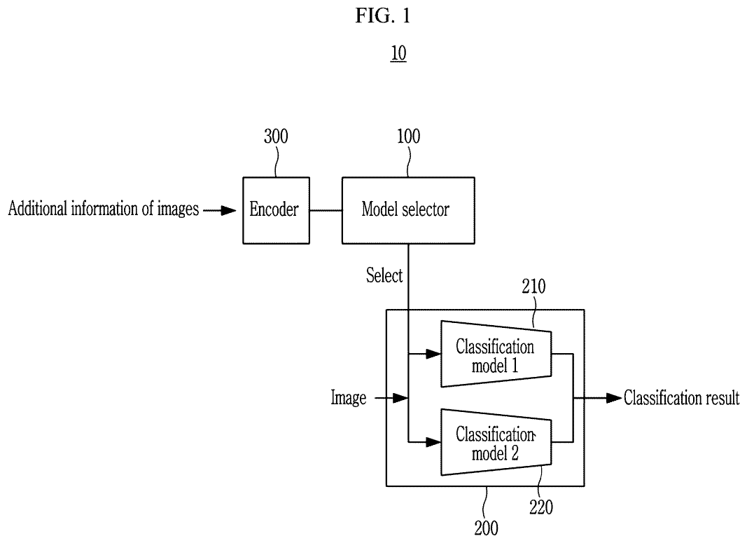

FIG. 1 illustrates a block diagram on an image classifying device according to one or more embodiments.

In some embodiments, an image classifying device 10 (e.g., an electronic device with image classification) may determine an input image as a bad image or may classify the input image as a specific class. For example, when the input image is an image of a semiconductor, the image classifying device 10 may determine whether the input semiconductor image is a bad image including defects or may determine a class indicating that the image is bad or has the defects.

Referring to FIG. 1, the image classifying device 10 according to one or more embodiments may include a model selector 100 and an image classifier 200.

In some embodiments, the model selector 100 may determine a classification model for classifying images by using an AI model based on additional information (e.g., encoded additional information) of the images. The model selector 100 may output a score between 0 and 1 from (e.g., based on) the additional information of the images by using an AI model and the classification model may be determined according to the output score.

For example, referring to FIG. 1, a first classification model 210 of the image classifier 200 may be selected when the model selector 100 outputs a score of less than 0.5 from the additional information of images by using the AI model, and a second classification model 220 of the image classifier 200 may be selected when the model selector 100 outputs a score of equal to or greater than 0.5 from the additional information of images by using the AI model.

In another example, the model selector 100 may output the score that corresponds to the respective classification models from the additional information of image by using an AI model. The classification model that corresponds to the highest score may be determined as the AI model for classifying images. For example, when the model selector 100 uses an AI model to output 0.94 as the score that corresponds to the first classification model 210 from the additional information of images and outputs 0.06 as the score that corresponds to the second classification model 220, the first classification model 210 of the image classifier 200 is selected. In an example, the total of all scores corresponding to the classification models (e.g., the first classification model 210 and the second classification model 220) may equal 1.

The model selector 100 may train the AI model to select the classification model that may further classify individual images based on the additional information of images. The model selector 100 may train the AI model for selecting a classification model in the image classifier 200 based on an image in a training set and the additional information of images, and may receive a reward from an evaluation result of performance of the image classifier 200 according to a result of selecting a classification model by the AI model.

The model selector 100 may select one of the classification models included in the image classifier 200 according to the task combination indicated by the additional information of the input image. An example of the task combination indicated by the additional information is described below.

In some embodiments, the image classifier 200 may include classification models, and the respective classification models may classify the input image into at least one class by using an artificial neural network structure thereof, such as a convolution neural network (CNN). For example, the classification models of the image classifier 200 may respectively output the score that corresponds to the class from the input image.

In some embodiments, the image classifier 200 may train the classification models, and the training of the classification models may be separately performed from the training of the model selector 100. For example, when the model selector 100 is trained, the classification model selected by the trained model selector 100 may be trained by using the image that corresponds to the additional information used in the selection. The classification model determined by a random selection from among the classification models may be provided to train the model selector 100.

Referring to FIG. 1, when the classification model is selected by the model selector 100, the image classifier 200 may input the image that corresponds to the additional information used for the selection of the classification model by the model selector 100 to the selected classification model, and the input image may be classified by the selected classification model.

Referring to FIG. 1, the image classifier 200 may include two classification models 210 and 220, and the image classifier 200 may include more classification models. When the image classifier 200 includes at least three classification models, the number of parameters used in storing models increases so time and costs for learning the respective classification models may increase. In addition, when the image classifier 200 includes at least three classification models, a task combination indicated by the additional information is processed by the greater number of the classification models, thereby reducing performance of generalizing the classification models. However, when the image classifier 200 includes at least three classification models, the image classifier 200 of one or more embodiments may classify the images by using the greater number of parameters, thereby increasing the image classifying performance.

When the image classifier 200 includes at least three classification models, the scores that correspond to the respective classification models output by the model selector 100 may be used in determining the classification models. For example, the classification model that corresponds to the highest score may be determined as the AI model for classifying images. For example, when the model selector 100 outputs 0.03 as the score that corresponds to the first classification model 210 from the additional information of images by using an AI model, outputs 0.06 as the score that corresponds to the second classification model 220, and outputs 0.91 as the score that corresponds to a third classification model, the images may be classified by the third classification model of the image classifier 200. In an example, the total of all scores corresponding to the classification models (e.g., the first classification model 210, the second classification model 220, and the third classification model) may equal 1.

Referring to FIG. 1, the image classifying device 10 according to one or more embodiments may further include an encoder 300. The encoder 300 may encode the additional information and may transmit the encoded additional information to the model selector 100 so that the model selector 100 may identify the additional information.

In some embodiments, the encoder 300 may encode discrete additional information (e.g., categorical data and discrete numerical data) into a vector (e.g., one-hot vector) that has real numbers as elements. In some embodiments, the encoder 300 may add continuous (e.g., continuous numerical data) additional information (e.g., a real number value) to the vector. When a natural language is included in the additional information, the encoder 300 may encode the natural language in the additional information by using a word-to-vector for encoding the natural language into a vector.

In some embodiments, the additional information of images may include various data relating to images such as an image generating device or image generating conditions, and the image classifying device 10 of one or more embodiments may increase image classifying performance by using the additional information. For example, the additional information of images may include information (product information, etc.,) on photographing targets, information (identifiers of testing devices, etc.,) on photographing devices, information (brightness, color temperatures, etc.,) on photographing conditions, and information on photographing angles and locations.

The additional information may indicate domains to which the images belong. For example, the images generated by different photographing devices may belong to different domains, and the image generated at different photographing angles may belong to different domains. Hence, the additional information may include information on the domains to which the individual images belong.

In some embodiments, when the task indicates classification of images that belong to at least one domain, additional information of a specific image may correspond to the task combination of the tasks according to the domains to which the specific image belongs. The model selector 100 may be trained to select the classification model for maximizing the performance of classifying the input image according to the task combination indicated by the additional information of the input image.

Equation 1 below, for example, may represent the additional information of images.

$$Equation 1$$

$$Additional info . : [ \begin{matrix}{d}_{1} \\ {d}_{2} \\ {d}_{3} \\ {d}_{4} \\ {d}_{5} \\ ⋮ \\ {d}_{n}\end{matrix} ] = [ \begin{matrix}Product types \text{:} \{ 0 , ⋯ , n \} \\ Test device types \text{:} \{ 0 , ⋯ , m \} \\ Image photographing angles \text{:} \{ front , rear , lateral \} \\ Image photographing locations \text{:} x - coordinate \\ Image photographing locations \text{:} y - coordinate \\ ⋮ \\ {d}_{n}\end{matrix} ]$$

Referring to Equation 1, when images of a product are acquired by a test device (e.g., including one or more cameras) in a process for product manufacturing, the additional information of images may include product types, test device types, image photographing angles, and image photographing locations (x-coordinate and y-coordinate). When the product types are n, the test device types are m, and the photographing angles are three including a front side, a rear side, and a lateral side, regarding the additional information, the number of the task combination may be n×m×3. Here, when the task on the photographing location expressed as a real number is combined, the number of the task combinations may be several hundreds to several thousands.

The model selector 100 may select the classification model to maximize the image classifying performance based on the additional information of images, such that the image classifying device 10 of one or more embodiments may more accurately classify the images using the classification model optimized to the task combination that corresponds to the additional information, and such that the image classifying device 10 of one or more embodiments may reduce the cost and time used in the classification of images.

For example, when a rear image of the semiconductor of Type 2 from among the n-numbered different types of the semiconductors is photographed at the location of the coordinate (3.5, 11.7) by the test device of Type 1 from among the m-numbered test devices, the additional information of the semiconductor image may be expressed as in Equation 2 below, for example.

$$Additional info . : [ \begin{matrix}( 0 , 1 , 0 , ⋯ , 0 ) \\ ( 1 , ⋯ , 0 ) \\ ( 0 , 1 , 0 ) \\ 3.5 \\ 11.7\end{matrix} ] \qquad Equation 2$$

Here, the vector encoded from the additional information may include three one-hot vectors and two real numbers. The encoder 300 may generate the additional information in a dimension of n+m+3+1+1, and for easy identification, the one-hot vector is shown in a horizontal way in Equation 2. The vector of the additional information encoded by the encoder 300 may include an n-dimensional one-hot vector in which a second element is 1, an m-dimensional one-hot vector in which a first element is 1, and a 3-dimensional one-hot vector in which a second element is 1. Further, the vector of the additional information encoded by the encoder 300 may include 3.5 that indicates the x-coordinate of the photographing location of the semiconductor image and 11.7 that indicates the y-coordinate of the photographing location of the semiconductor image.

The additional information that corresponds to the encoded vector expressed in Equation 2 may show that the corresponding image belongs to the domains. For example, the image may belong to the domain of the semiconductor product of Type 2, may belong to the domain in which the image is generated by the test device of Type 1, may belong to the domain including a rear image, and may belong to the domain including the image photographed at the coordinate (3.5, 11.7). Therefore, when it is defined by one task for the classification model to classify the images belonging to the respective domains, the vector encoded from the additional information of images may correspond to one task combination. For example, the vector of Equation 2 may represent combinations among a task for classifying the image of the semiconductor product domain of Type 2, a task for classifying the image of the test device domain of Type 1, a task for classifying the image of the rear domain, and a task for classifying the image photographed at the coordinate (3.5, 11.7).

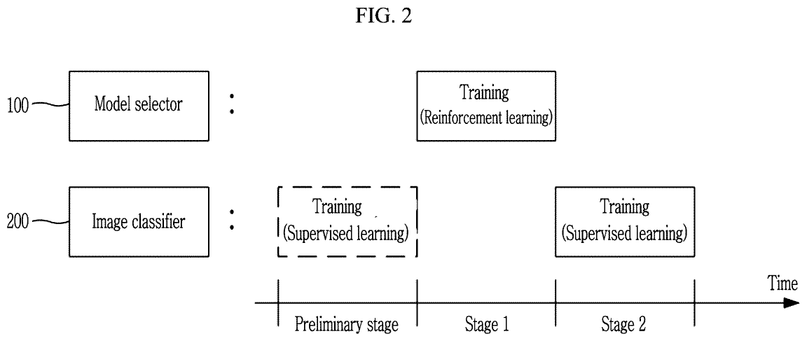

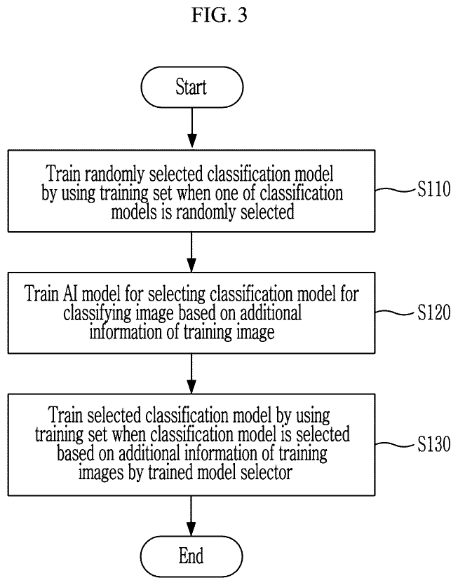

FIG. 2 illustrates a method for training an image classifying device according to one or more embodiments, and FIG. 3 illustrates a method for training an image classifying device according to one or more embodiments. Operations S110 to S130 to be described hereinafter may be performed sequentially in the order and manner as shown and described below with reference to FIG. 3, but the order of one or more of the operations may be changed, one or more of the operations may be omitted, and two or more of the operations may be performed in parallel or simultaneously without departing from the spirit and scope of the example embodiments described herein.

In some embodiments, the training of the image classifying device 10 may include training the model selector 100 (e.g., operation Stage 1) and training the image classifier 200 (e.g., operation Stage 2). Here, the image classifier 200 may train the classification model (Preliminary Stage), and the model selector 100 may be trained (e.g., operation Stage 1) using the trained classification model. The training (e.g., operation Sof the model selector 100 (e.g., operation Stage 1) and the training (e.g., operation Sof the image classifier 200 (e.g., operation Stage 2) may be repeated by a predetermine number of times. For example, when Stage 2 ends, the training (e.g., operation Sof the model selector 100 (e.g., operation Stage 1) and the training (e.g., operation Sof the image classifier 200 (e.g., operation Stage 2) may be performed again.

Referring to FIG. 2, in the Preliminary Stage, the image classifier 200 may train a randomly selected classification model through a supervised learning by using a training set. It may be a preliminary training for the training of the image classifying device 10 that the image classifier 200 trains the randomly selected classification model through the supervised learning. The trained classification model to be used in training the model selector 100 may be trained (Preliminary Stage) by using the same data set used in training the model selector 100 (e.g., operation Stage 1).

In another example, the classification models of the image classifier 200 may be trained in advance (Preliminary Stage) by using the data set that is different from the training set used in training the model selector 100 (e.g., operation Stage 1). By using the classification model trained in advance in training the model selector 100, the image classifying device 10 of one or more embodiments may increase versatility of the image classifying device 10 and may reduce the time and cost used for the training.

In the Preliminary Stage, one of the classification models included in the image classifier 200 may be randomly selected. The selected classification model may be trained by using a training image in the training set, and another classification model may be selected to be trained according to the next training image in the training set.

For example, one classification model may be determined by random selection between the two classification models for training using one training image in the training set, and one classification model may be determined again by random selection between the two classification models for training using the next training image in the training set. The training images in the training set may be provided to train one of the classification models included in the image classifier 200, and the corresponding of the respective classification models to the training image may be arbitrary, and the image classifier 200 may perform a supervised learning on the respective classification models by using different training images. The two different training images in the training set may be used to train the same classification model or the different classification models, and the different classification models may be trained by using different training images.

In some embodiments, the classification models included in the image classifier 200 may have different structures. For example, a classification model 1 (e.g., the first classification model 210) from among the classification models may have a CNN structure, and a classification model 2 (e.g., the second classification model 220) from among the classification models may be a transfer learning-based artificial neural network model, a recurrent neural network (RNN) model, a long short-term memory (LSTM), and/or a gated recurrent unit (GRU). In some embodiments, when the classification models have different structures, training times and costs of the respective classification models may be identical or similar to each other.

Referring to FIG. 2, in Stage 1, an AI model of the model selector 100 that performs an action for selecting the classification model according to a policy may be trained through a reinforcement learning. Here, the policy may be determined by the AI model based on the additional information of the training image, rewards may be determined according to changes of performance of the image classifier 200 caused by a result of selecting the classification model, and the policy may be updated according to sizes of the rewards. The current performance of the image classifier 200 may be input as a state to the model selector 100.

In detail, the model selector 100 may select a classification model for classifying the corresponding training image based on the policy determined based on the additional information of the training image. The image classifier 200 may classify the corresponding training image by using the selected classification model, and may perform a supervised learning on the selected classification model through a feedback of a loss function result caused by the classification.

In some embodiments, the model selector 100 may evaluate performance of the image classifier 200 by using an evaluation image when the training on the classification models in the image classifier 200 is performed by using the training image in a batch. In some embodiments, when performance of the image classifier 200 is increased or reduced according to selection of the classification model based on the policy of the model selector 100, the change of performance of the image classifier 200 may be fed back as a reward to the model selector 100. In Stage 1, the changed performance of the image classifier 200 may be provided, as a new state of the model selector 100, to the next stage of the reinforcement learning of the AI model.

When the training of the model selector 100 through a reinforcement learning ends, the classification model that is supervised learned while training the model selector 100 may be initialized to a state that is prior to the training of the model selector 100. In Stage 2, the classification model may be selected according to the policy of the trained model selector 100, and the classification model selected by the model selector 100 may be trained by using the training set.

Referring to FIG. 3, in the preliminary stage of training the image classifying device 10, one of the classification models may be randomly selected, and the image classifier 200 may train the randomly selected classification model through a supervised learning by using the image in the training set (e.g., operation S110).

In some embodiments, the classification model included in the image classifier 200 may have the CNN structure. While training the image classifier 200, one classification model may be randomly selected for one training image, and a process for the selected classification model to perform a supervised learning by using the training set may be repeated.

A predetermined number of the images may be randomly sampled in the training set to form the batch, and the image classifier 200 may train the randomly selected classification model per batch. The randomly sampled image may not be repeatedly sampled, and the different batches may not include the same image.

When the classification models in the image classifier 200 are randomly selected, and the selected classification models learn the training images in one batch, the batch may be sampled in the training set, and the classification model selected for the training image in the next batch may be trained. When the batches are trained, one epoch ends, and the image classifier 200 may train the next epoch by using a new sampled batch in the training set. In some embodiments, the classification model included in the image classifier 200 may be trained for a predetermined number of times (e.g., 20 to 30 times) of the epoch.

The model selector 100 may train the AI model for selecting the classification model for classifying images based on the additional information of images of the training set (e.g., operation S120). The additional information of the training image may be encoded into a vector, and the model selector 100 may train the AI model so that the AI model may output the score for selecting the classification model from the encoded vector.

In some embodiments, the model selector 100 may train the AI model for selecting the classification model through a reinforcement learning. The model selector 100 may learn the policy for selecting the classification model for classifying the corresponding training image by using the additional information of the respective training images in the training set, and may receive a result (changes of conditions) of the actions according to the learned policy as a feedback. The action according to the learned policy may correspond to the selection of the classification models for classifying the respective images, and it may correspond to the changes of conditions whether the performance of the image classifier 200 trained by the accumulated selections of the model selector 100 becomes better or worse. The change of performance of the image classifier 200 may be fed back to the model selector 100 as a reward. The model selector 100 may update the policy based on the reward. For example, the model selector 100 may update the policy so that the selection of the classification models that correspond to the training images in the batch may maximize the reward caused by the increase of performance of the image classifier 200.

When the training of the model selector 100 through a reinforcement learning ends, the classification models trained during the reinforcement learning of the model selector 100 may be initialized to the state that is prior to the reinforcement learning of the model selector 100 starts.

Referring to FIG. 3, when the training of the model selector 100 through a reinforcement learning ends, the trained model selector 100 may select the classification model based on the additional information of the training image, and the image classifier 200 may train the classification model selected by the trained model selector 100 through a supervised learning by using the training image (e.g., operation S130). For example, the classification models of the image classifier 200 may be trained through the supervised learning based on the selection of the model selector 100 trained through the reinforcement learning.

As described above, when many task combinations may be indicated by the additional information, the trained model selector 100 may deduce the classification model for maximizing the classification performance on the input image of the image classifier 200. For example, when the trained model selector 100 selects the classification model according to a classification reference for maximizing the performance of classifying input images, the image classifying device 10 of one or more embodiments may classify the images using the optimal classification model on the task combination that corresponds to the additional information, and may thus reduce the cost and time used in classifying images.

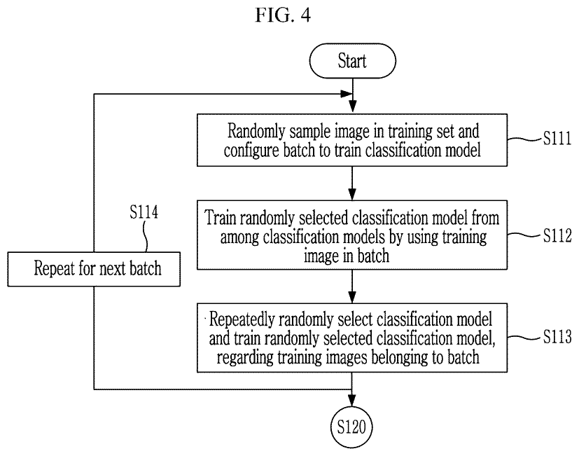

FIG. 4 illustrates a method for training a classification model according to one or more embodiments. Operations S111 to S114 to be described hereinafter may be performed sequentially in the order and manner as shown and described below with reference to FIG. 4, but the order of one or more of the operations may be changed, one or more of the operations may be omitted, and two or more of the operations may be performed in parallel or simultaneously without departing from the spirit and scope of the example embodiments described herein.

An example of the preliminary-stage training of the image classifying device 10 of FIG. 2 will now be described with reference to FIG. 4.

Referring to FIG. 4, a predetermined number of images in the training set may be randomly sampled, thereby making the batch (e.g., operation S111). The classification model may be trained per a batch. In some embodiments, the training image of the batch may not be repeatedly sampled in the training set, and the different batches may not include the same image.

Referring to FIG. 4, the image classifier 200 may train the classification model randomly selected from among the classification models through a supervised learning by using the training image of the batch (e.g., operation S112).

In some embodiments, one classification model determined by a random selection may correspond to one training image in the batch, and the classification model randomly selected from among the classification models may correspond to the next training image in the batch. For example, the respective training images in the batch may be used in training one of the classification models in the image classifier 200.

Referring to FIG. 4, the random selection of the classification model in the image classifier 200 and the training of the randomly selected classification model may be repeated for the training images in the batch (e.g., operation S113). When the training of the randomly selected classification model using the training image of one batch ends, the randomly selected classification model may be trained again by using the next batch of the training set (e.g., operation S114).

In some embodiments, when one epoch including a predetermined number of the batches ends, the image classifier 200 may start a new epoch based on the new configured batch. The image classifier 200 may end the training (preliminary stage) of the randomly selected classification model when each of the classification models are converged or a predetermined number of the epochs end.

As described above, the preliminary stage of FIG. 2 may be arbitrarily performed to provide the trained classification model to be used in the training of the model selector 100.

According to one or more embodiments, in the preliminary stage, the same data set as the training set used in training the model selector 100 may be used, or a data set that is different from the training set used in training the model selector 100 may be used.

In another example, in the preliminary stage, the classification model with a relatively simple structure may be trained. The classification model to be used in the reinforcement learning of the model selector 100 is initialized when the reinforcement learning of the model selector 100 ends, such that a lot of costs and time may be used in the training of the model selector 100 when the classification model with a relatively complicated structure is used. Hence, the image classifier 200 of one or more embodiments may train the classification model with a low cost structure through the preliminary stage and may provide the trained classification model with a low cost structure for the purpose of training the model selector 100.

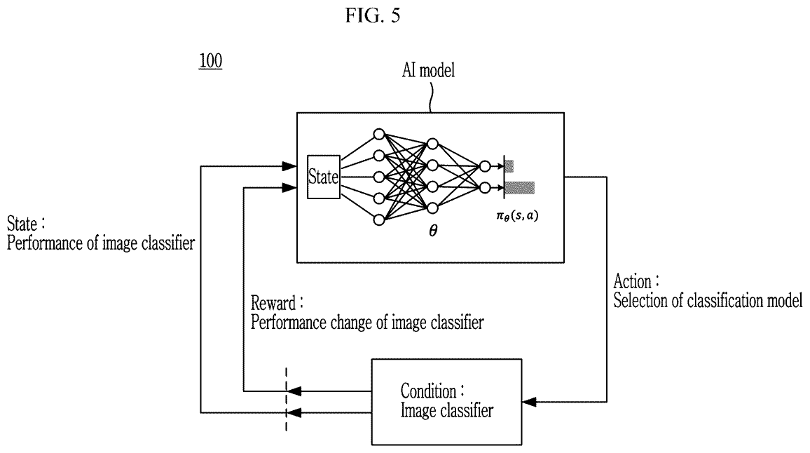

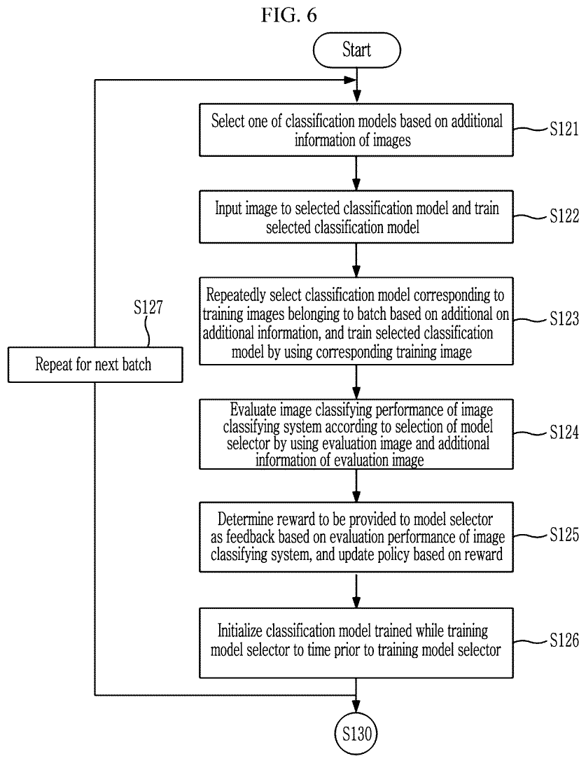

FIG. 5 shows a reinforcement learning structure of a model selector according to one or more embodiments, and FIG. 6 shows a flowchart on a method for training a model selector using a trained classification model according to one or more embodiments. Operations S121 to S127 to be described hereinafter may be performed sequentially in the order and manner as shown and described below with reference to FIG. 6, but the order of one or more of the operations may be changed, one or more of the operations may be omitted, and two or more of the operations may be performed in parallel or simultaneously without departing from the spirit and scope of the example embodiments described herein.

An example of the Stage-1 training of the image classifying device 10 of FIG. 2 will now be described with reference to FIG. 5 and FIG. 6.

Referring to FIG. 5, the model selector 100 may train the AI model for selecting the classification model according to the policy through the reinforcement learning. The policy may be determined by the AI model based on the additional information of the image, and the action may be the score output from the additional information of the input image according to the policy by the AI model. The classification model in the image classifier 200 may be selected for the input image depending on the size of the score, and performance of the image classifier 200 may be changed according to the result of selecting the classification model. Current performance of the image classifier 200 may be input as a state to the model selector 100. The change of performance of the image classifier 200 may be provided to the model selector 100 as a feedback reward, and the model selector 100 may update the policy based on the reward.

Referring to FIG. 6, the model selector 100 may select one of the classification models in the image classifier 200 based on the additional information of the training image of the training set (e.g., operation S121). In some embodiments, the model selector 100 may be trained per batch, and the batch may include the randomly sampled training image in the training set. The batches may be configured from one training set, and the respective batches may not include the same image.

In some embodiments, the model selector 100 may output the score from the additional information of images by using the AI model according to the policy, and the classification model may be determined according to the output score. For example, the first classification model of the image classifier 200 may be selected when the model selector 100 outputs the score of less than a predetermined value (e.g., 0.5) from the additional information of images by using the AI model, and the second classification model of the image classifier 200 may be selected when the model selector 100 outputs the score of the predetermined value or more from the additional information of images by using the AI model. In another example, the model selector 100 may output the scores that correspond to the respective classification models from the additional information of images by using the AI model according to the policy, and the classification model that corresponds to the highest score may be determined as the AI model for classifying images.

Referring to FIG. 6, the image classifier 200 may train the selected classification model by inputting the corresponding training image to the selected classification model (e.g., operation S122). The model selector 100 may select the classification models that correspond to the training images belong to the batch based on the additional information of the training images, and the image classifier 200 may train the classification model selected by the model selector 100 by using the corresponding training image, which may be repeated (e.g., operation S123).

The classification models in the image classifier 200 may be trained by using the training images belonging to one batch, and image classifying performance of the image classifier 200 according to the selection of the classification model by the model selector 100 may be evaluated as a performance score by using evaluation images and additional information of the evaluation images (e.g., operation S124). The evaluation images are one type of the training images, and the training images and the evaluation images may be provided with a predetermined ratio (e.g., 9:1) in the training set.

Referring to FIG. 6, the reward to be provided to the model selector 100 as a feedback may be determined based on a performance score of the image classifier 200, and the model selector 100 may update the policy for selecting the classification model that corresponds to the individual image based on the feedback reward (e.g., operation S125). The reward to be provided to the model selector 100 as a feedback may be determined based on a difference between a performance score of the image classifier 200 and a reference performance score. For example, the reward provided to the model selector 100 as a feedback may be determined by a sum of the difference between the performance score of the image classifier 200 and the reference performance score and a predetermined fixed value. When the performance score and the reference performance score of the image classifier 200 show accuracy expressed as real numbers between 0 and 1, the reward provided to the model selector 100 as a feedback may be determined as an addition of 0.5 and the difference between the performance score and reference performance score as expressed in Equation 3 below, for example.

$$Equation 3$$

$$Reward = 0.5 + ( performance score - reference performance score )$$

In some embodiments, the reference performance score of the image classifier 200 may be predetermined as an arbitrary value or may be predetermined based on the evaluation image and the additional information of the evaluation image before the model selector 100 is trained. For example, when the evaluation image and additional information of the evaluation image are provided to the model selector 100 that is not trained, the model selector 100 may select the classification model for classifying evaluation image by using the additional information of the evaluation image, and the evaluation image may be classified by the selected classification model. A result of classifying the evaluation images by the image classifying device 10 may be determined as the reference performance score of the image classifier 200.

When the reward is provided to the model selector 100 as a feedback, the classification model trained while the model selector 100 is trained through the reinforcement learning may be initialized to a time before the model selector 100 is trained (e.g., operation S126). Referring to FIG. 2, the classification model trained while the model selector 100 is trained through the reinforcement learning may be initialized to a boundary position between Preliminary Stage and Stage 1.

Referring to FIG. 6, when the policy of the model selector 100 is updated based on the reward provided as a feedback, the model selector 100 may perform a training again by using a training image of a new batch and additional information of the training image (e.g., operation S127). Regarding the training of the model selector 100 using a new batch, the same classification model as the training using a previous batch may be used.

In some embodiments, one epoch ends when the model selector 100 performs a training by using the batches included in the training set, and the model selector 100 may perform a training of the next epoch by using the new sampled batch in the training set. In some embodiments, the model selector 100 may end the training when the model is converged or a predetermined number (e.g., two to three times) of the epochs end.

A classification model with a relatively simple structure may be used to train the model selector 100. For example, the classification model used in the reinforcement learning of the model selector 100 may have fewer layers than the trained classification model. By using the classification model trained during the reinforcement learning of the model selector 100 to train the model selector 100 and initializing the model selector 100 to the time that is prior to training, the image classifying device 10 of one or more embodiments may use a low-cost artificial neural network with a simple structure as the classification model used for the reinforcement learning of the model selector 100, and may reduce the time and cost used in training the model selector 100. The image classifier 200 of one or more embodiments may train the classification model with a low-cost structure in the preliminary stage of FIG. 2 and may provide the trained classification model with a low-cost structure for the purpose of the reinforcement learning of the model selector 100, thereby reducing the time and cost used in training the model selector 100.

When the classification model learned in advance by using the data set that is different from the training set used in training the model selector 100 is used, the model selector 100 may be trained (e.g., operation Stage 1 of FIG. 2), and the image classifier 200 may not be trained (e.g., operation Stage 2 of FIG. 2). By using the classification model learned in advance by using the different data sets, the image classifying device 10 of one or more embodiments may improve versatility of the image classifying device 10 and may reduce the time and cost used in the training.

As described above, the model selector 100 of one or more embodiments may learn the classify reference executed through the reinforcement learning, thereby maximizing the classifying performance of the image classifier 200.

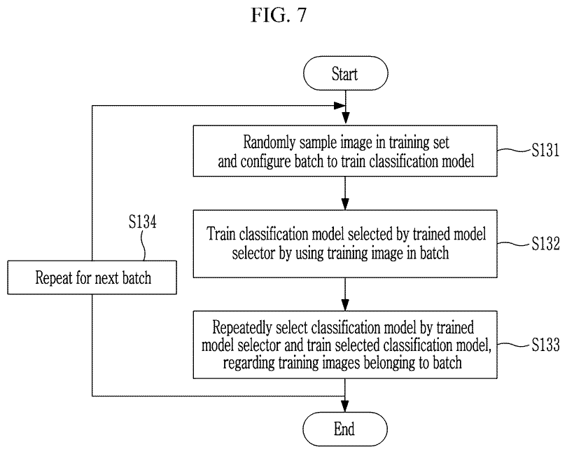

FIG. 7 shows a flowchart on a method for training a classification model using a trained model selector according to one or more embodiments. Operations S131 to S134 to be described hereinafter may be performed sequentially in the order and manner as shown and described below with reference to FIG. 6, but the order of one or more of the operations may be changed, one or more of the operations may be omitted, and two or more of the operations may be performed in parallel or simultaneously without departing from the spirit and scope of the example embodiments described herein.

An example of the Stage-2 training of the image classifying device 10 of FIG. 2 will now be described with reference to FIG. 7.

Referring to FIG. 7, to train the classification model using the trained model selector 100, a predetermined number of images in the training set may be randomly sampled to configure the batch (e.g., operation S131). The classification model may be trained per batch. In some embodiments, the training image belonging to the batch may not be repeatedly sampled from the training set, and the different batches may not include the same image.

Referring to FIG. 7, the image classifier 200 may train the classification model selected by the trained model selector 100 from among the classification models through the supervised learning by using the training image of the batch (e.g., operation S132). The trained model selector 100 may select the classification model according to the policy learned to classify one image in the batch, and the image classifier 200 may train the classification model selected through the supervised learning by using the corresponding image.

Referring to FIG. 7, the model selector 100 trained in Stage 1 of FIG. 2 may select the respective classification models on the training images in the batch, and the image classifier 200 may repeatedly train the selected classification model for the training image in the batch (e.g., operation S133). When the training of the classification model selected by the trained model selector 100 ends by using one batch, the classification model is selected again on the next batch of the training set by the trained model selector 100, and the selected classification model may be trained again by the next batch of the training set (e.g., operation S134).

In some embodiments, the image classifier 200 may start a new epoch based on the new configured batch when one epoch with a predetermined number of batches ends. The image classifier 200 may end the training of the classification model selected by the trained model selector 100 when the classification models are converged or a predetermined number (e.g., 20 to 30 times) of the epochs end.

The image classifier 200 may not train the classification model shown in FIG. 7 when the classification model trained in advance is used by using the data set that is different from the training set used in training the model selector 100. When using the classification model learned in advance by using different data sets, the image classifying device 10 of one or more embodiments may train the model selector 100 and not train the image classifier 200, thereby reducing the time and cost used in training the image classifying device 10.

The classification model with a relatively simple structure may be used in training (e.g., operation Stage 1) the model selector 100, and the classification model with a relatively complicated structure may be used in training (e.g., operation Stage 2) the image classifier 200. For example, the classification model used in the reinforcement learning of the model selector 100 may have fewer layers than the classification model used in training the image classifier 200. The image classifying device 10 of one or more embodiments may use the classification model with a low-cost structure in training the model selector 100 so the model selector 100 may be trained with low power within a short time, and may use the high-performance classification model in training the image classifier 200 so the effect of selecting the classification model by the trained model selector 100 may be maximized.

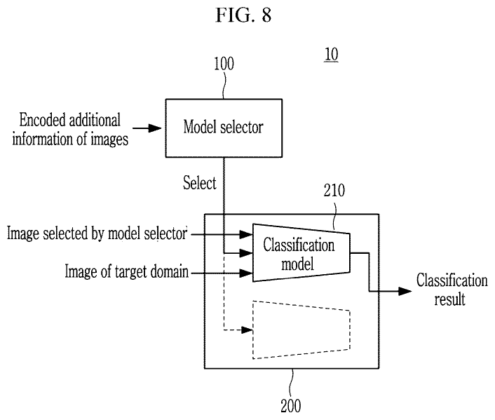

FIG. 8 shows a block diagram on an image classifying device according to an example.

In another example, the image classifying device 10 may be used for domain adaptation on a target domain. The domain adaptation may be performed when the model selector 100 and the image classifier 200 of the image classifying device 10 are trained, and performance of classifying the image in a specific target domain is to be increased.

In another example, the model selector 100 of the image classifying device 10 may provide some training images of the training set to the classification model to increase the performance of classifying the target image of the classification model of the image classifier 200. For example, the model selector 100 may provide the training image that is similar to the target domain from among the training images of the training set to the image classifier 200 based on the additional information of the training image for the purpose of domain adaptation on the target domain. The classification model of the image classifier 200 may learn the target image of the target domain and the training image that is similar to the target domain to thus efficiently perform the domain adaptation on the target domain.

Referring to FIG. 8, the model selector 100 may select the training image for increasing performance of classifying the target image from the training set based on the additional information of images in the training set for the purpose of domain adaptation of the classification model of the image classifier 200.

In some embodiments, the model selector 100 may output the score between 0 and 1 from the additional information of images by using the AI model, and may transmit the corresponding image to the classification model when the output score is greater than a predetermined size. For example, when the model selector 100 outputs the score of 0.5 or more from the additional information of images by using the AI model, the corresponding image may be used to train the classification model.

In some embodiments, the model selector 100 may train the AI model through the reinforcement learning to provide the training image for increasing classifying performance on the image of the target domain to the image classifier 200.

For example, the model selector 100 may perform an action of selecting the training image for increasing the classifying performance on the target domain of the classification model according to the policy based on the additional information of the training image in the training set. The image classifier 200 may train the classification model by using the target image of the target domain and some training images in one batch selected by the model selector 100, and may measure classifying performance on the target domain of the trained classification model. The reward may be determined according to the performance increasing/decreasing widths of the trained classification model on the target domain, and the reward may be provided to the model selector 100 as a feedback. The model selector 100 may update the policy based on the feedback reward.

In some embodiments, when the policy for selecting the training image for increasing the performance on the target domain of the classification model is updated based on the reward provided to the model selector 100 as a feedback, the classification model trained during the reinforcement learning of the model selector 100 may be initialized.

In some embodiments, the image classifier 200 may train one classification model that corresponds to the target domain by using the target image of the target domain and the training image selected by the model selector 100 trained by the reinforcement learning. The image classifier 200 may train the image classifying of the classification model through the supervised learning. When the image classifier 200 includes the classification models, the image classifier 200 may train one classification model that corresponds to the target domain for the purpose of the efficiency of the domain adaptation on the target domain.

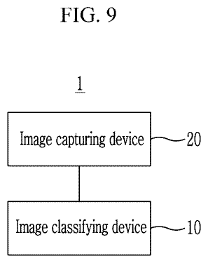

FIG. 9 shows an image classifying system of a semiconductor product according to one or more embodiments.

Referring to FIG. 9, an image classifying system 1 of a semiconductor product may include an image capturing device 20 (e.g., including one or more cameras) and an image classifying device 10.

In some embodiments, the image capturing device 20 may obtain (e.g., capture and/or generate) various types of images of products, such as wafers in the semiconductor manufacturing process or chips in the packaging stage. In this instance, regarding the image obtained by the image capturing device 20, additional information including product information, test device types, and image captured location and condition may be generated. In some embodiments, by using the additional information of images for image classifying, the image classifying system 1 of one or more embodiments may increase performance of the image classifying.

In some embodiments, the image classifying device 10 may classify the images based on the additional information of images transmitted from the image capturing device 20. For example, the image classifying device 10 may determine whether the input semiconductor image is a bad image including defects or may determine a bad class of the input semiconductor image.

As described above, the image classifying device 10 may include a model selector 100 and an image classifier 200. The model selector 100 may train the AI model through the reinforcement learning to select the classification model and increase the classifying performance on the images based on the additional information of images.

In some embodiments, the image classifier 200 may include classification models, and the respective classification models may classify the input image into at least one class by using the artificial neural network structure such as a convolution neural network (CNN). One classification model from among the classification models of the image classifier 200 may be determined by the model selector 100 trained for classifying input images, and the selected classification model may output the scores in which the input images correspond to the respective classes.

In some embodiments, the process for the image classifier 200 to train the classification models and the process for the model selector 100 to train them may be performed individually. For example, the model selector 100 is trained, and the classification model selected by the trained model selector 100 may be trained using the image that corresponds to the additional information used for the selection.

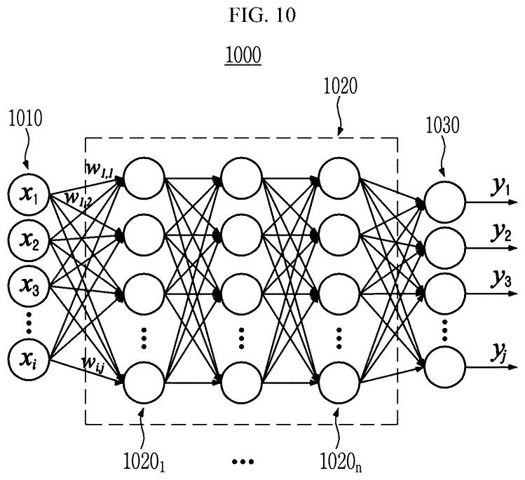

FIG. 10 illustrates a neural network of the AI model according to one or more embodiments.

Referring to FIG. 10, the first AI model and/or the second AI model according to one or more embodiments may have a neural network structure including an input layer 1010, a hidden layer 1020 (e.g., one or more hidden layers), and an output layer 1030. The neural network 1000 may have an encoder-decoder structure, and may constitute a portion and/or all of the generative AI model described above.

Each of the input layer 1010, the hidden layer 1020, and the output layer 1030 may each include a respective set of nodes, and the strength of connections between each node may correspond to a weight (a connection weight). The nodes included in the input layer 1010, the hidden layer 1020, and the output layer 1030 may be connected to each other with a fully connected type of architecture.

In some embodiments, the number of parameters (the weights and biases) may be equal to the number of connections within the neural network 1000. The input layer 1010 may include a plurality of input nodes (x₁ to xᵢ), and the number of input nodes (x₁ to xᵢ) may correspond to the number of independent variables of input data. In some embodiments, the input layer 1010 may have a structure for processing a large volume of inputs.

For training the AI model, a data set may be input to the input layer 1010. When a mask image of an inference target is input to the input layer 1010 of the trained AI model, a corrected mask image may be output as the inference result from the output layer 1030 of the trained AI model 1000.

The hidden layer 1020 may be positioned between the input layer 1010 and the output layer 1030, and may include at least one hidden layer 10201 to 1020n. The output layer 1030 may include at least one output node. An activation function may be used in the hidden layer 1020 and output layer 1030 to determine node outputs/actications.

In some embodiments, the AI model may be learned by updating the weights and/or parameters of a hidden node included in the hidden layer 1020.

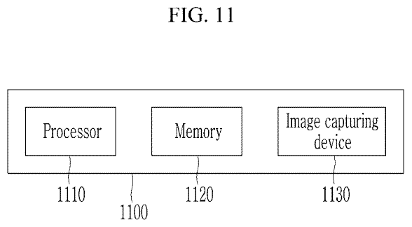

FIG. 11 illustrates a generating apparatus of a mask image according to another embodiment. The mask generation apparatus may be implemented as a computer system, for example, as a computer-readable medium (but not a signal per se).

Referring to FIG. 11, the computer system 1100 includes a processor 1110 (e.g., one or more processors), a memory 1120 (e.g., one or more memories), and an image capturing device 1130 (e.g., one or more cameras). The memory 1120 may be connected to the processor 1110 and may store instructions causing the processor 1110 to perform a plurality of operations or at least one prog+ram described above. For example, the memory 1120 may be or include a non-transitory computer-readable storage medium storing instructions that, when executed by the processor 1110, configure the processor to perform any one, any combination, or all of the operations and/or methods disclosed above with reference to FIGS. 1-10.

The processor 1110 may implement the function, process, or method proposed in the embodiments. An operation of the computer system 1100 may be implemented by the processor 1110. The processor 1110 may include at least one of a GPU, a CPU, an NPU, FPGA, and/or DSP. In practice the processor 1110, may be one or more processors of one or more types. When the operation of the computer system 1100 is implemented by a plurality of processors of the processor 1110, each work may be divided according to the load among the plurality of processors. For example, when one of the processors is a CPU, another of the processors may be any of a GPU, NPU, FPGA, and/or DSP.

In the embodiments of the present disclosure, the memory 1120 may be positioned internally or externally to the processor and the memory may be connected to the processor via a variety of known means. The memory 1120 may be a type of storage medium that may be volatile or non-volatile. For example, the memory 1120 may include a read-only memory (ROM) or a random access memory (RAM).

In some embodiments, the image capturing device 1130 may obtain (e.g., capture and/or generate) various types of images of products, such as wafers in the semiconductor manufacturing process or chips in the packaging stage. In this instance, regarding the image obtained by the image capturing device 1130, additional information including product information, test device types, and image captured location and condition may be generated. In some embodiments, by using the additional information of images for image classifying, the computer system 1100 of one or more embodiments may increase performance of the image classifying.

In another example, some functions (e.g., training the yield predicting model and/or the path generating model, inference by the yield predicting model and/or the path generating model) of the yield predicting device may be provided by a neuromorphic chip including neurons, synapses, and inter-neuron connection modules. The neuromorphic chip is a computer device simulating biological neural system structures, and may perform neural network operations.

Meanwhile, embodiments are not implemented only through the devices and/or methods described so far, but may also be implemented through a program that realizes a function corresponding to the configuration of embodiments or a recording medium in which the program is recorded, and such implementation can be easily implemented by a person skilled in the art to which the present description belongs based on the description of the embodiments described above. For example, a method according to one or more embodiments (e.g., an image preprocessing method, etc.) can be implemented in the form of a program instruction that can be performed through various computer means and recorded on a computer-readable medium. The computer-readable medium may include program instructions, data files, data structures, etc., alone or in combination. The program instructions recorded on the computer-readable medium may be specially designed and configured for embodiment, or may be known and available to those skilled in the art of computer software. A computer-readable recording medium may include a hardware device configured to store and execute program instructions. For example, the computer-readable recording medium can be magnetic media such as hard disks, floppy disks, and magnetic tape, optical media such as CD-ROMs and DVDs, magneto-optical media such as floptical disks, ROM, RAM, flash memory, etc. Program instructions may include machine language code, such as that produced by a compiler, as well as high-level language code that can be executed by a computer through an interpreter, etc. Although the embodiments have been described in detail above, the scope of this disclosure is not limited thereto, and various modifications and improvements of a person of an ordinary skill in the art utilizing the basic concepts defined in the following claims also fall within the scope of this disclosure.

The image classifying devices, model selectors, image classifiers, encoders, image classifying systems, image capturing devices, computer systems, processors, memories, image classifying device 10, model selector 100, image classifier 200, encoder 300, image classifying system 1, image classifying device 10, image capturing device 20, computer system 1100, processor 1110, memory 1120, image capturing device 1130, and other apparatuses, devices, units, modules, and components described herein, including descriptions with respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (e.g., operation SISD) multiprocessing, single-instruction multiple-data (e.g., operation SIMD) multiprocessing, multiple-instruction single-data (MISD) multiprocessing, and multiple-instruction multiple-data (MIMD) multiprocessing.

The methods illustrated, and discussed with respect to, in FIGS. 1-10 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (e.g., operation SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (e.g., operation SSD), flash memory, a card type memory such as multimedia card micro or a card (for example, secure digital (e.g., operation SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

In one or more embodiments of the description, the memory 1120 may be disposed inside or outside the processor, and the memory may be connected to the processor through various means already known. The memory may be a volatile or nonvolatile storage medium of various forms, and for example, the memory may include a read-only memory (ROM) or a random access memory (RAM).

On the other hand, the embodiments are not implemented only by the apparatus and/or the method as described above, but may be implemented by programs realizing the functions corresponding to the configuration of the embodiments or a recording medium recorded with the programs, which may be readily implemented by a person having ordinary skill in the art to which the description pertains from the description of the foregoing embodiments. Specifically, the method (e.g., a data augmentation method or the like) according to one or more embodiments may be implemented in the form of program instructions that may be executed through various computer means to be recorded on a computer-readable medium. The computer-readable medium may include program instructions, data files, data structures, and the like, independently or in combination thereof. The program instructions recorded on the computer-readable medium may be specially designed and configured for the embodiment, or may be known to those skilled in the art of computer software so as to be used. The computer-readable recording medium may include a hardware device configured to store and execute the program instructions. For example, the computer-readable recording medium may be a hard disk, a magnetic media such as a floppy disk and a magnetic tape, an optical media such as a CD-ROM and a DVD, a magneto-optical media such as a floptical disk, a ROM, a RAM, a flash memory, or the like. The program instructions may include a high-level language code that may be executed by a computer using an interpreter or the like, as well as a machine language code generated by a compiler.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An electronic device comprising:
one or more processors configured to:
select a classification model for classifying an image from among classification models based on additional information of the image by using an artificial intelligence (AI) model; and
classify the image by using the selected classification model.

2. The device of claim 1, wherein
the AI model and the classification models are sequentially trained, and
the classification models are trained through a supervised learning based on a selection of the classification models by the trained AI model.

3. The device of claim 2, wherein
the AI model is trained through a reinforcement learning, and
for the reinforcement learning, the one or more processors are configured to:
select the classification model according to a policy based on additional information of a training image in a training set for the reinforcement learning;
receive a reward determined based on a change of performance of the selected classification model; and
update the policy based on the reward.

4. The device of claim 3, wherein the reward is determined based on a difference between a performance score of the selected classification model and a reference performance score determined by using an evaluation image and additional information of the evaluation image.

5. The device of claim 4, wherein the reference performance score is determined based on either one or both of:
an arbitrary value; and
the evaluation image and the additional information of the evaluation image prior to the training of the AI model.

6. The device of claim 3, wherein the selected classification model used in the reinforcement learning of the AI model has fewer layers than the trained classification models trained through the supervised learning.

7. The device of claim 3, wherein the classification model used in the reinforcement learning of the AI model is learned in advance by using a data set that is different from the training set.

8. The device of claim 1, wherein the additional information includes information of domains to which the image belongs.

9. The device of claim 1, wherein, for the selecting of the classification model, the one or more processors are configured to output scores corresponding to respective classification models between 0 and 1 from the additional information by using the AI model.

10. The device of claim 9, wherein a first classification model is selected from among the classification models in response to the AI model outputting the score of less than a predetermined value and a second classification model is selected from among the classification models in response to the AI model outputting the score of equal to or greater than the predetermined value.

11. The device of claim 1, wherein, for the selecting of the classification model, the one or more processors are configured to select one of the classification models based on scores corresponding to respective classification models determined from the additional information by using the AI model.

12. A processor-implemented method comprising:
training an artificial intelligence (AI) model by:
selecting a classification model for classifying an image according to a policy based on additional information of the image;
determining a reward according to performance of the selected classification model that is trained based on the image; and
updating the policy based on the reward.

13. The method of claim 12, wherein the updating of the policy based on the reward comprises updating the policy such that the selecting of the classification model maximizes the reward according to the evaluated performance.

14. The method of claim 12, wherein the determining of the reward according to the performance of the selected classification model that is trained based on the image comprises:
determining a performance score of the selected classification model trained based on the image; and
determining the reward based on a difference between the evaluated performance score of the selected classification model and a reference performance score.

15. An electronic system comprising:
an image capturing device configured to acquire an image of the semiconductor product and generate additional information of the image; and
an image classifying device configured to select a classification model for classifying the image from among classification models by using an artificial intelligence (AI) model based on the additional information of the image and classify the image by using the selected classification model.

16. The system of claim 15, wherein the classification models are sequentially trained through a supervised learning based on selection of the AI model.

17. The system of claim 16, wherein the AI model is trained through a reinforcement learning comprising:
selecting the classification model according to a policy based on additional information of a training image in a training set,
receiving a reward determined based on a change of performance of the selected classification model, and
updating the policy based on the reward.

18. The system of claim 17, wherein the classification model used in the reinforcement learning of the AI model is learned in advance by using a data set that is different from the training set.

19. The system of claim 18, wherein the additional information includes information of domains to which the image belongs.

20. The system of claim 19, wherein the selected classification model is determined from among the classification models in response to the AI model outputting a score between 0 and 1 from the additional information.
